(19) United States
(12) Patent Application Publication
(10) Pub. No.: US 2026/0287954 A1
(43) Pub. Date: Sep. 24, 2026

(54) LIQUID CRYSTAL DEVICE AND ELECTRONIC APPARATUS

(71) Applicant: SEIKO EPSON CORPORATION, Tokyo (JP)

(72) Inventors: Shogo TAKAHASHI, CHINO-SHI (JP); Shuji TERADA, MATSUMOTO-SHI (JP)

(73) Assignee: SEIKO EPSON CORPORATION, Tokyo (JP)

(21) Appl. No.: 19/570,192

(22) Filed: Mar. 18, 2026

(30) Foreign Application Priority Data
Mar. 19, 2025 (JP) 2025-044759

(51) Int. Cl. G02F 1/1362; G02F 1/1337; G02F 1/1368

(52) U.S. Cl. CPC G02F 1/136286; G02F 1/1337; G02F 1/1368

(57) ABSTRACT

In a liquid crystal device of the present disclosure, in plan view, an end portion of the pixel electrode anterior to a center line in a predetermined direction in which liquid crystal molecules of a liquid crystal layer are inclined in an unapplied state of voltage in the pixel electrode overlaps at least one line of a scanning line and a data line.

The present application is based on, and claims priority from JP Application Serial Number 2025-044759, filed Mar. 19, 2025, the disclosure of which is hereby incorporated by reference herein in its entirety.

### BACKGROUND

### 1. Technical Field

The present disclosure relates to a liquid crystal device and an electronic apparatus.

### 2. Related Art

In general, a transmissive electro-optical device including a liquid crystal device includes a first substrate, a second substrate, and a liquid crystal layer provided between the first substrate and the second substrate. A plurality of pixel electrodes that transmit incident light and an alignment film that covers the pixel electrodes are provided on one plate surface of the first substrate. An alignment film is provided on a surface of the second substrate facing the first substrate.

In a plan view viewed along an axis parallel to the thickness direction of the first substrate, the pixel electrode overlaps a light transmission region surrounded by a first light-shielding region extending along a first axis contained in a surface orthogonal to the thickness direction of the first substrate and a second light-shielding region extending along a second axis contained in the surface orthogonal to the thickness direction of the first substrate and intersecting the first axis. The plan view shape of the pixel including the pixel electrode and the plan view shape of the light transmission region are substantially rectangular, for example, square. In the light transmission region, image light provided with image information based on incident color light is generated.

In the electro-optical device having the above-described configuration, it has been confirmed that, when the plan view shape of the light transmission region is rectangular, the degrees of deterioration in display quality due to a transverse electric field applied from the adjacent pixel electrodes are different between the first axis or the second axis along the long side of the light transmission region and the second axis or the first axis along the short side of the light transmission region.

For example, in an electro-optical device disclosed in JP-A-2019-148625, the dimension of the light transmission region on the second axis is smaller than the dimension of the light transmission region on the first axis. When the electro-optical device disclosed in JP-A-2019-148625 is viewed in plan view, the center of the pixel electrode is deviated from the center of the light transmission region to the azimuth side in which the liquid crystal molecules are pre-tilted in the direction along the second axis.

JP-A-2019-148625 is an example of the related art.

Also in the electro-optical device disclosed in JP-A-2019-148625, due to a transverse electric field generated between pixel electrodes adjacent to each other in plan view, disclination of liquid crystal molecules contained in the liquid crystal layer occurs. The disclination of the liquid crystal molecules occurs near the end surface of the pixel electrode in accordance with the deposition direction of the alignment film, which determines the alignment of the liquid crystal molecules, on the plate surface of each substrate. Due to the occurrence of the disclination of the liquid crystal molecules, the transmittance of the image light in the end portion of the light transmission region in plan view decreases, and thus an observer may visually recognize the region with the decreased transmittance as a domain region, and the display quality of the electro-optical device may deteriorate. That is, there is a demand for measures for reducing the visibility of domains due to disclination of liquid crystal molecules and increasing the display quality of the liquid crystal device.

### SUMMARY

A liquid crystal device according to an aspect of the present disclosure includes a pair of substrates and a liquid crystal layer sandwiched between the pair of substrates. A first substrate of the pair of substrates includes a plurality of scanning lines extending along a first axis in plan view, a plurality of data lines extending along a second axis intersecting the first axis in plan view, a pixel electrode disposed to include a part of a region surrounded by the scanning lines adjacent to each other and the data lines adjacent to each other in plan view and having a rectangular shape in plan view, and an alignment film provided at a side in contact with the liquid crystal layer and providing a pretilt to liquid crystal molecules contained in the liquid crystal layer. A second substrate of the pair of substrates includes a counter electrode facing the pixel electrode with the liquid crystal layer in between, and an alignment film provided at a side in contact with the liquid crystal layer and providing a pretilt to the liquid crystal molecules. In the liquid crystal device according to the aspect of the present disclosure, in plan view, an end portion of the pixel electrode anterior to a center line in a predetermined direction in which the liquid crystal molecules are inclined in the pixel electrode overlaps at least one line of the scanning line and the data line.

### BRIEF DESCRIPTION OF THE DRAWINGS

FIG. 1 is a plan view of a liquid crystal device according to one embodiment of the present disclosure.

FIG. 2 is a cross-sectional view of the liquid crystal device in FIG. 1.

FIG. 3 is a cross-sectional view of a part of the liquid crystal device in FIG. 1.

FIG. 4 is an equivalent circuit diagram of the liquid crystal device in FIG. 1.

FIG. 5A is a plan view of a first substrate of the liquid crystal device in FIG. 1.

FIG. 5B is a cross-sectional view of the first substrate in FIG. 5A.

FIG. 5C is a cross-sectional view of the first substrate in FIG. 5A.

FIG. 5D is a cross-sectional view of the first substrate in FIG. 5A.

FIG. 6 is a plan view of a first substrate of a modification of the liquid crystal device in FIG. 1.

FIG. 7 is a schematic diagram of a projector including the liquid crystal device in FIG. 1.

### DESCRIPTION OF EMBODIMENTS

Embodiments of the present disclosure will be described below with reference to the drawings. In the drawings, the dimensional scales of component elements may vary for clarity of the respective component elements.

In the following description, an X axis, a Y axis, and a Z axis are illustrated as three axes orthogonal to one another. One side along the X axis is referred to as a +X side, and a side opposite to the +X side along the X axis is referred to as a −X side. Similarly, one side along the Y axis is referred to as a +Y side, and a side opposite to the +Y side along the Y axis is referred to as a −Y side. One side along the Z axis is referred to as a +Z side, and a side opposite to the +Z side along the Z axis is referred to as a −Z side. A plane including the X axis and the Y axis may be referred to as an “XY plane”, and a view of the XY plane along the Z axis may be referred to as a “plan view”.

In the following description, for example, with respect to a substrate, the description “on the substrate” represents one of a case where a portion is disposed in contact with the upper surface of the substrate, a case where a portion is disposed via a component element such as a structure other than the substrate on the upper surface of the substrate, and a case where a part of a portion is disposed in contact with the upper surface of the substrate and another part is disposed via a component element other than the substrate. The material and the film thickness of each component element of the liquid crystal device 100 are not limited to the exemplified material and film thickness except for a case where a suitable reason or the like is described.

In one embodiment of the present disclosure, as a liquid crystal device and an electro-optical device, an active drive type and transmission type liquid crystal device including a thin film transistor (TFT) as a switching element for each pixel will be described as an example. In the following description, the thin film transistor may be abbreviated as a TFT. The liquid crystal device is suitably used as, for example, a light modulation device in a projector as an electronic apparatus described later, and corresponds to an electro-optical element.

### Outline of Physical Structure of Liquid Crystal Device

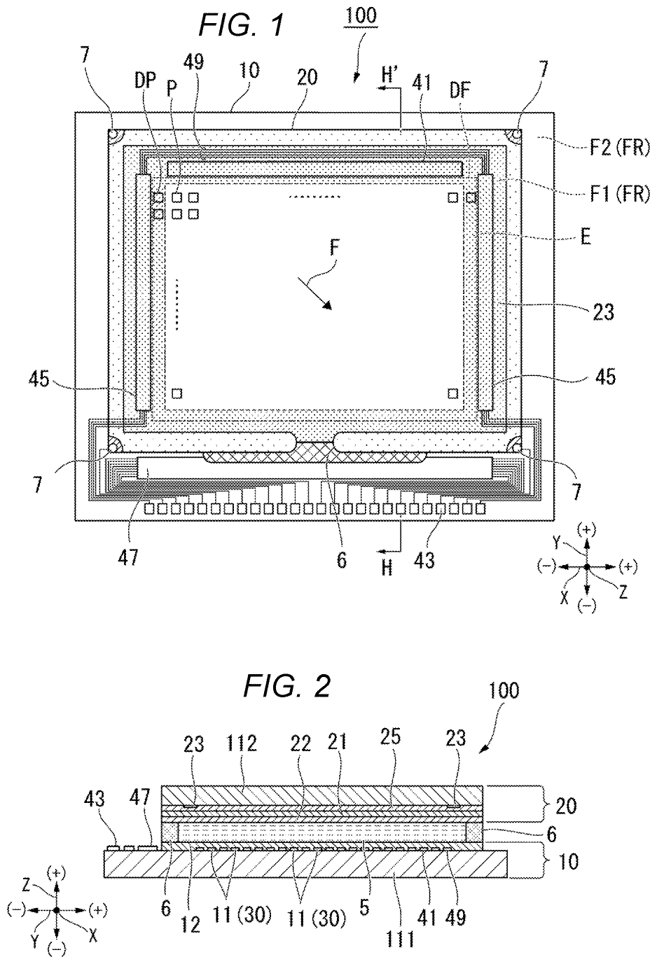

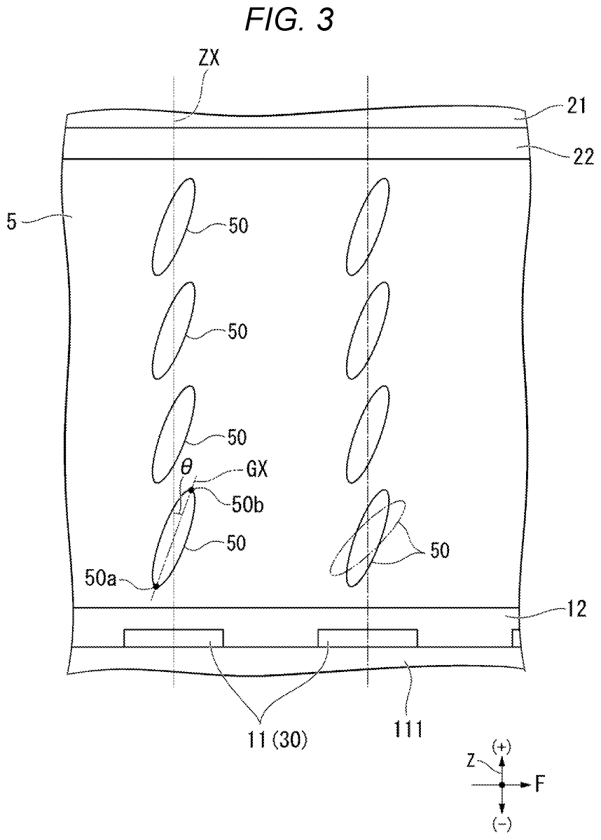

FIG. 1 is a plan view of a liquid crystal device 100 according to the present embodiment. FIG. 2 is a cross-sectional view of the liquid crystal device 100, taken along line H-H′ in FIG. 1. As illustrated in FIGS. 1 and 2, the liquid crystal device 100 includes a first substrate 10, a second substrate 20, and a liquid crystal layer 5. The second substrate 20 is disposed so as to face the first substrate 10. The first substrate 10 and the second substrate 20 correspond to a pair of substrates. The liquid crystal layer 5 is sandwiched between the first substrate 10 and the second substrate 20 along the Z axis, and functions as an electro-optical layer of the liquid crystal device 100. The liquid crystal layer 5 includes a plurality of liquid crystal molecules (not illustrated).

As an element substrate 111 of the first substrate 10 and a counter substrate 112 of the second substrate 20, substrates formed of a material capable of transmitting color light incident on the liquid crystal device 100 are used, and for example, substrates such as glass substrates or quartz substrates are used.

In plan view, the dimension of the first substrate 10 along the X axis and the dimension thereof along the Y axis are larger than those of the second substrate 20. The first substrate 10 and the second substrate 20 are bonded to each other on the Z axis via a sealing material 6 disposed along the outer edge of the second substrate 20. Liquid crystal having positive or negative dielectric anisotropy is enclosed in a space surrounded by the first substrate 10, the second substrate 20, and the sealing material 6, and thus the liquid crystal layer 5 is provided.

In plan view, a display region E including a plurality of pixels P is provided inside the sealing material 6. The plurality of pixels P are arranged in a matrix along the X axis and the Y axis. In plan view, a region outside the display region E is a peripheral region FR. In plan view, dummy pixels DP are provided in a first peripheral region F1 between the sealing material 6 and the display region E of the peripheral region FR. The first peripheral region F1 surrounds the display region E on the XY plane. The dummy pixels DP are arranged in a region closest to the display region E in the first peripheral region F1. The region where the dummy pixels DP are arranged is a dummy pixel region DF that does not contribute to display.

In plan view, a partition member 23 surrounding the display region E is provided in the first peripheral region F1. For example, an inspection circuit 41 is provided in a region between the display region E and the sealing material 6 on one side extending along the X axis and disposed at the +Y side on the Y axis in the first peripheral region F1. A scanning line drive circuit 45 is provided in a region between each of the sealing materials 6 on two sides extending along the X axis and the display region E in the first peripheral region F1. A plurality of wires 49 coupling the two scanning line drive circuits 45 are provided in a region between the sealing material 6 and the inspection circuit 41 in the first peripheral region F1.

A plurality of external coupling terminals 43 are provided in the second peripheral region F2 of the first substrate 10 outside the sealing material 6 in the peripheral region FR. For example, the plurality of external coupling terminals 43 extend along the X axis and are disposed at intervals along the X axis in the second peripheral region F2 at the −Y side on the Y axis. In plan view, in the second peripheral region F2, a data line drive circuit 47 is provided between the region where the plurality of external coupling terminals 43 are disposed and the sealing material 6 extending along the X axis.

The wires 49 are coupled to the data line drive circuit 47 and the scanning line drive circuits 45, and are coupled to the plurality of external coupling terminals 43. The inspection circuit 41 may be disposed in a region different from the above-described region, that is, the region between the sealing material 6 on one side extending along the X axis and disposed at the +Y side on the Y axis and the display region E.

As illustrated in FIG. 2, thin film transistors 30, the inspection circuit 41, the wires 49, and an alignment film 12 are provided on the surface facing the liquid crystal layer 5 in the element substrate 111 as the base material of the first substrate 10. The thin film transistor 30 is a switching element provided for each pixel P. The alignment film 12 covers pixel electrodes 11, the thin film transistors 30, and the wires 49. The thin film transistor 30 and the pixel electrode 11 are component elements of the pixel P. The first substrate 10 includes these component elements of the element substrate 111, the pixel electrodes 11, the thin film transistors 30, the wires 49, and the alignment film 12 and the inspection circuit 41.

The partition member 23, an insulating layer 25, a counter electrode 21, and an alignment film 22 are provided on a surface of the counter substrate 112 as the base material of the second substrate 20 facing the liquid crystal layer 5. The insulating layer 25 covers the partition member 23. The counter electrode 21 is disposed as a common electrode provided to cover the insulating layer 25. The alignment film 22 covers the counter electrode 21. The second substrate 20 includes these component elements of the partition member 23, the counter electrode 21, and the alignment film 22 and the insulating layer 25.

The counter electrode 21 as the common electrode is provided in the second substrate 20 as an example, but may be provided in the first substrate 10. For example, an insulating layer (not illustrated) that covers the thin film transistors 30, the inspection circuit 41, and the wires 49 may be provided, and the counter electrode 21 may be provided between the insulating layer (not illustrated) described above and the alignment film 12.

As illustrated in FIG. 1, in plan view, the scanning line drive circuits 45 and the inspection circuit 41 overlap the partition member 23. The partition member 23 functions as a light-shielding region. Light including color light or the like to enter the liquid crystal device 100 is emitted from a light source device (not illustrated) and is incident on the second substrate 20 of the liquid crystal device 100 from the +Z side along the Z axis. The partition member 23 shields the light entering the liquid crystal device 100 from entering a peripheral circuit including the scanning line drive circuit 45. The partition member 23 is provided to prevent malfunction of the peripheral circuit. The partition member 23 shields unnecessary stray light from entering the display region E. The partition member 23 is provided to suppress reduction in contrast in the liquid crystal device 100.

The insulating layer 25 is formed of, for example, an inorganic material such as silicon oxide (SiO₂) having light transmissivity with respect to light incident on the liquid crystal device 100. The surface of the insulating layer 25 in contact with the liquid crystal layer 5 is a planar surface parallel to the XY plane.

In plan view, conducting members 7 are provided in four corners of the sealing material 6 and extend along the Z axis. The counter electrode 21 is electrically coupled to the conducting members 7. The conducting members 7 are electrically coupled to a common wire 18 described later.

The pixel electrodes 11 and the counter electrode 21 are formed of, for example, a transparent conductive film of indium tin oxide (ITO) or indium zinc oxide (IZO). The material of the alignment films 12 and 22 is selected based on the optical design of the liquid crystal device 100. Examples of the material of the alignment films 12 and 22 include inorganic compounds such as silicon dioxide (SiO₂), titanium dioxide (TiO₂), and magnesium oxide (MgO), and organic compounds such as polyimide.

The liquid crystal device 100 employs an optical design of a normally white mode or a normally black mode. In the normally white mode, the transmittance of the pixel P when a voltage is not applied is larger than the transmittance when a voltage is applied. In the normally black mode, the transmittance of the pixel P when a voltage is not applied is smaller than the transmittance when a voltage is applied. In the following description, it is assumed that the optical design of the normally black mode is adopted in the liquid crystal device 100. In accordance with the optical design of the liquid crystal device 100, polarization elements (not illustrated) are disposed in a space at the light incident side and a space at the light exiting side with respect to the liquid crystal device 100.

FIG. 3 is a cross-sectional view of a portion including the liquid crystal layer 5, the end of the first substrate 10 at the +Z side, and the end of the second substrate 20 at the −Z side in the liquid crystal device 100, when the above-described portion is cut along a plane including the Z axis and an F direction illustrated in FIG. 1.

Specifically, the alignment film 12 is formed by obliquely depositing columnar bodies (not illustrated) made of the inorganic compound or the organic compound described above on the surface at the +Z side and the side surfaces of the plurality of pixel electrodes 11 and the surface at the +Z side not covered with the plurality of pixel electrodes 11 in the insulating layer formed at the most +Z side in the first substrate 10. The alignment film 22 is formed by similarly obliquely depositing columnar bodies made of the inorganic compound or the organic compound described above on the surface at the −Z side of the counter electrode 21. The central axes or the major axes of the columnar bodies configuring the respective alignment films 12 and 22 are inclined in the F direction in plan view along the Z axis as illustrated in FIG. 1. The F direction indicates a direction of movement from the +Y side to the −Y side with movement from the −X side to the +X side along the X axis, and corresponds to a predetermined direction. In the following description, the anterior side in the F direction may be referred to as a +F side, and the posterior side in the F direction may be referred to as a −F side. In plan view, the F direction forms angles from 40° to 50° with respect to the X axis and the Y axis. As will be described later, when a region RT corresponding to the transmission region of the pixel P has a square shape in plan view, the F direction preferably forms angles of 45° with respect to the X axis and the Y axis.

As shown in FIG. 3, the liquid crystal layer 5 has a plurality of liquid crystal molecules 50. The liquid crystal molecule 50 has an elongated shape and has a major axis GX which is a central axis in the longitudinal direction and a minor axis orthogonal to the center of the major axis GX. The cross-sectional shape including the major axis GX of the liquid crystal molecule 50 is an ellipse, and the cross-sectional shape including the minor axis of the liquid crystal molecule 50 is a substantially perfect circle.

The alignment films 12 and 22 are appropriately designed based on optical characteristics required for the liquid crystal device 100, and are formed such that the columnar bodies are in appropriate orientations. Although not illustrated in FIG. 3, in a cross-sectional view along a plane including the Z axis and the F direction, the central axes of the plurality of columnar bodies of the alignment films 12 and 22 are inclined at least with respect to the Z axis, and move from the −F side to the +F side as moving from the −Z side to the +Z side.

As illustrated in FIG. 3, in an unapplied state in which a predetermined voltage is not applied to the plurality of pixel electrodes 11 and the counter electrode 21 of the liquid crystal device 100, the orientations of the long axes GX of the plurality of liquid crystal molecules 50 of the liquid crystal layer 5 are aligned with one another by the alignment films 12 and 22. That is, the alignment films 12 and 22 have functions of aligning the plurality of liquid crystal molecules 50 in the F direction in the unapplied state of voltage in the liquid crystal device 100.

In the unapplied state of voltage in the liquid crystal device 100, the orientations from ends 50a at the first substrate 10 side, that is, the −Z side of the long axes GX of the respective liquid crystal molecules 50 of the liquid crystal layer 5 to ends 50b at the second substrate 20 side, that is, the +Z side of the long axes GX are inclined at an angle θ with respect to an axis ZX parallel to the Z axis and passing through the center of the long axes GX. The angle θ is also called a pretilt angle, and is at least less than 45°, for example, within a range from 4° to 6°. The axis ZX and the Z axis correspond to a third axis described later.

In the unapplied state of voltage in the liquid crystal device 100, the ends 50b of the liquid crystal molecules 50 are located at the +F side and the +Z side with respect to the ends 50a of the liquid crystal molecules. Although not illustrated, in plan view, the ends 50b of the liquid crystal molecules 50 are located at the +F side, the −Y side, and the +X side of the end 50a of the liquid crystal molecules.

In an applied state in which a predetermined voltage is applied to the plurality of pixel electrodes 11 and the counter electrode 21 of the liquid crystal device 100, the tilt angle formed by the long axes GX of the plurality of liquid crystal molecules 50 that behave in the normally black mode with respect to the axis ZX is larger than the angle θ. In the applied state of voltage in the liquid crystal device 100, the orientations of the plurality of liquid crystal molecules 50 tilt toward the XY plane more than the orientations in the unapplied state.

### Outline of Electrical Structure of Liquid Crystal Device

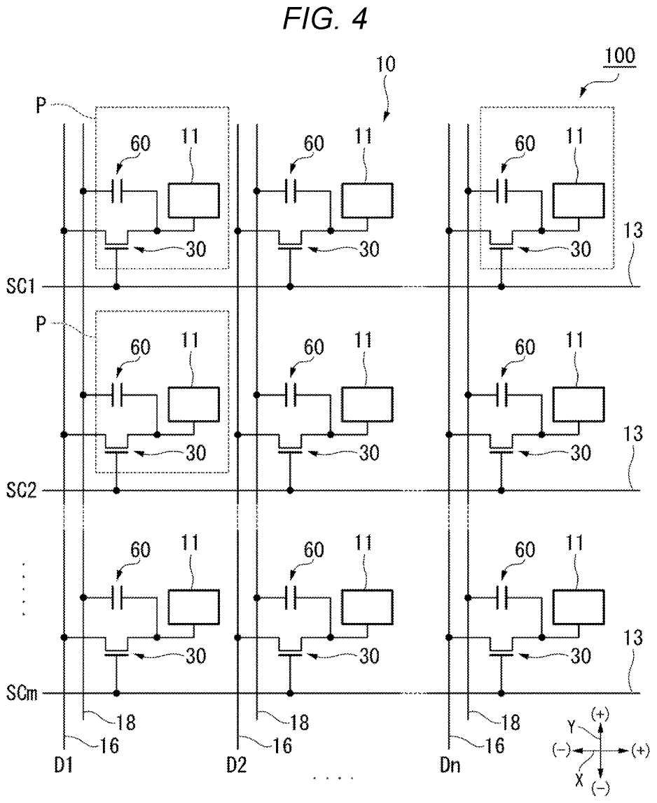

FIG. 4 is an equivalent circuit diagram of the liquid crystal device 100. As illustrated in FIG. 4, in the liquid crystal device 100, a plurality of scanning lines 13, a plurality of data lines 16, and a plurality of common wires 18 are provided on the element substrate 111 of the first substrate 10. The plurality of scanning lines 13 extend parallel to the X axis. The plurality of data lines 16 and the plurality of common lines 18 extend parallel to the Y axis. The plurality of data lines 16 intersect at least the plurality of scanning lines 13. That is, the direction in which the scanning lines 13 extend and the direction in which the data lines 16 extend are different from each other. The plurality of common lines 18 do not necessarily extend along the Y axis, and the direction in which the common lines 18 extend is not limited to a specific direction.

The pixels P are partitioned by the scanning lines 13 extending along the X axis and the data lines 16 extending along the Y axis. The pixel P is provided with the pixel electrode 11, the thin film transistor 30, and a capacitance element 60.

The scanning line 13 is electrically coupled to the gate of the thin film transistor 30. The data line 16 is electrically coupled to the source of the thin film transistor 30. The scanning line 13 simultaneously controls on and off of the thin film transistors 30 provided in the same row. The pixel electrode 11 is electrically coupled to the drain of the thin film transistor 30.

The data lines 16 are electrically coupled to the data line drive circuit 47, and supply the image signals D1, D2, . . . , Dn supplied from the data line drive circuit 47 to the pixels P. The scanning lines 13 are electrically coupled to the scanning line drive circuit 45, and supply scanning signals SC1, SC2, . . . , SCm supplied from the scanning line drive circuit 45 to the respective pixels P.

The image signal D1 to the image signal Dn supplied from the data line drive circuit 47 to the data lines 16 may be sequentially supplied, or may be collectively supplied for each group of the plurality of data lines 16 adjacent to each other. The scanning line drive circuit 45 sequentially supplies the scanning signal SC1 to the scanning signal SCm to the scanning lines 13 as pulses at predetermined times.

When the scanning signal SC1 is input to the thin film transistor 30, the TFT 30 is turned on for a certain period. Accordingly, the image signal D1 supplied from the data line 16 is written in the pixel electrode 11 at a predetermined time. The image signal D1 at a predetermined level written in the liquid crystal layer 5 via the pixel electrode 11 is held for a certain period between the counter electrode 21, which is disposed to be opposed via the pixel electrode 11 and the liquid crystal layer 5, and the element substrate.

The capacitive element 60 is electrically coupled in parallel to a liquid crystal capacitor provided between the pixel electrode 11 and the counter electrode 21. This prevents leakage of the image signal D1 held in the liquid crystal layer 5. The capacitive element 60 is electrically coupled to the pixel electrode 11 and the common wire 18.

Although omitted in FIG. 4, the inspection circuit 41 is coupled to the data line 16. Therefore, in the manufacturing process of the liquid crystal device 100, it is possible to check the presence or absence of a defect in the operation of the liquid crystal device 100 by detecting the image signals D1, D2, . . . , Dn.

### Outline of Electrical Structure of Electro-Optical Element

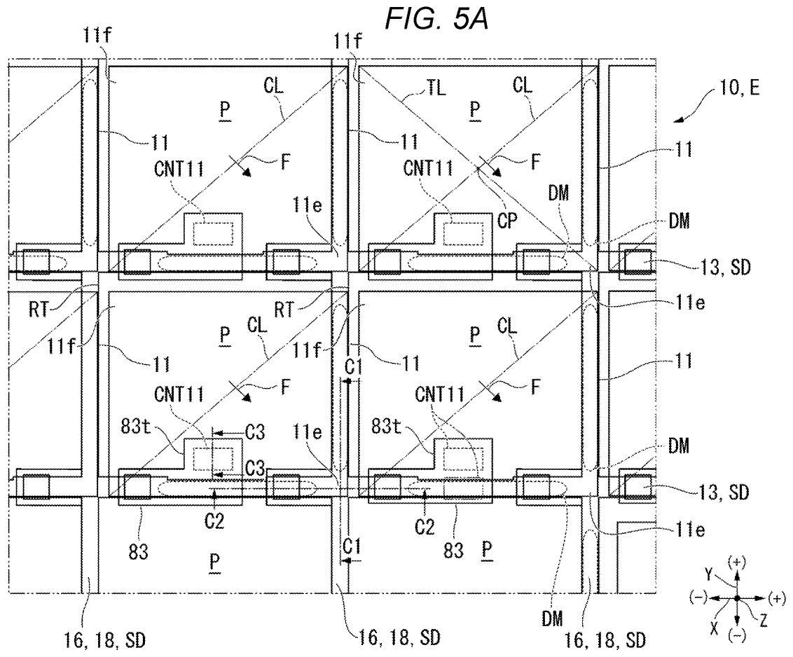

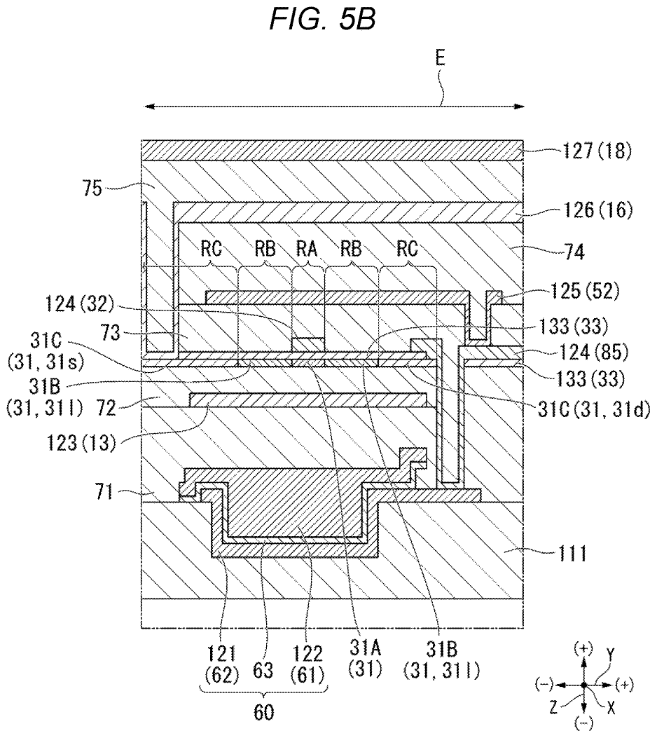

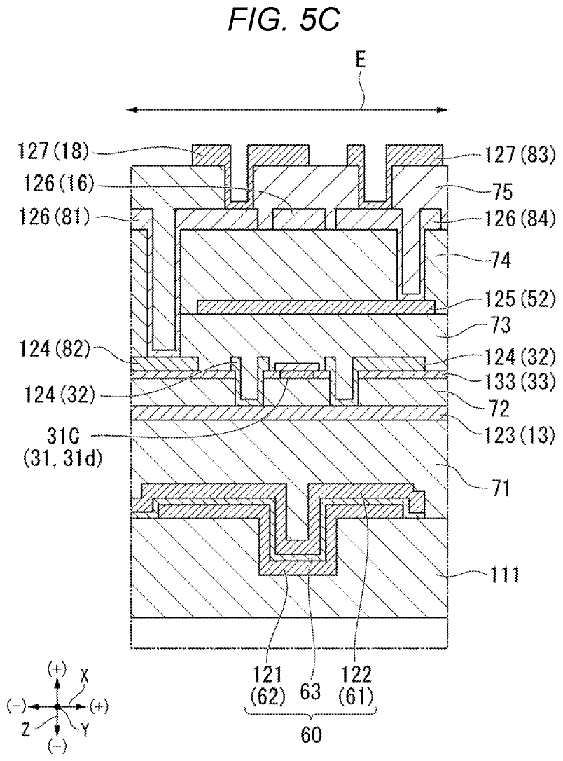

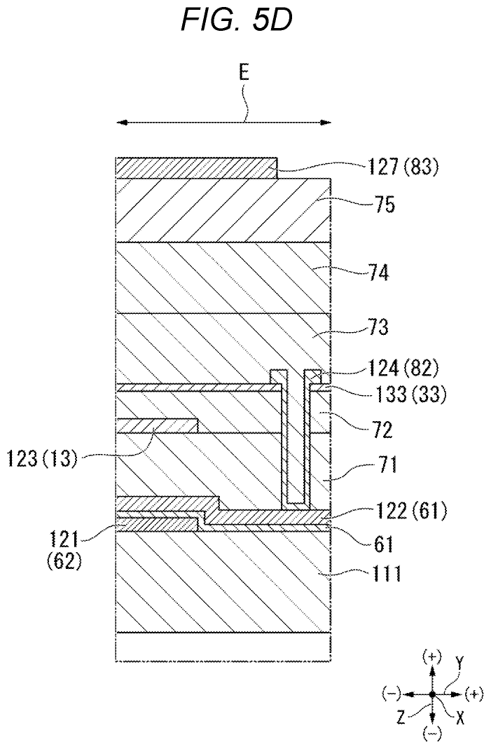

FIG. 5A is a plan view of the pixels P of the liquid crystal device 100 and is a plan view of the first substrate 10. FIG. 5B is a cross-sectional view of the pixel P taken along line C1-C1 shown in FIG. 5A in directions of arrows. FIG. 5C is another cross-sectional view of the pixel P taken along line C2-C2 shown in FIG. 5A in directions of arrows. FIG. 5D is a cross-sectional view of the pixel P taken along line C3-C3 in FIG. 5A in directions of arrows. In each of FIGS. 5B to 5D, the upper structure of the pixel P described later is omitted.

As illustrated in FIGS. 5A to 5D, a first conductive layer 121, a second conductive layer 122, a third conductive layer 123, a semiconductor layer 31, a fourth conductive layer 124, a fifth conductive layer 125, a sixth conductive layer 126, a seventh conductive layer 127, and the pixel electrode 11 are sequentially stacked on the element substrate 111 from the −Z side to the +Z side.

The first conductive layer 121 includes a second capacitance electrode 62 of the capacitance element 60. The second conductive layer 122 includes a first capacitance electrode 61 of the capacitance element 60. The third conductive layer 123 is formed of a conductive material having a light-shielding property, and includes the scanning line 13. The semiconductor layer 31 and the fourth conductive layer 124 configure the thin film transistor 30. As the thin film transistor 30, a top gate structure and an LDD (Lightly Doped Drain) structure are adopted. The semiconductor layer 31 includes a semiconductor layer 31A in a first region RA, semiconductor layers 31B in a second region RB, and semiconductor layers 31C in a third region RC. The fourth conductive layer 124 includes a gate electrode 32 of the thin film transistor 30. An insulating film 133 as a gate insulating film 33 is provided between the semiconductor layer 31 and the gate electrode 32 of the fourth conductive layer 124.

The semiconductor layer 31A is provided adjacent to the gate electrode 32 of the fourth conductive layer 124 via the gate insulating film 33 on the Z axis. That is, the semiconductor layer 31A is disposed below the gate electrode 32 with the gate insulating film 33 in between.

The semiconductor layers 31B are adjacent to the semiconductor layer 31A on the Y axis and are provided at the +Y side and the −Y side of the semiconductor layer 31A in the semiconductor layer 31. An impurity such as phosphorus (P) is implanted into the semiconductor layer 31B. The semiconductor layers 31C include the remaining portions in the semiconductor layer 31 other than the semiconductor layers 31A and 31B, are adjacent to the semiconductor layers 31B along the Y axis, and are provided at the +Y side and the −Y side of the semiconductor layers 31B. Similar to the semiconductor layers 31B, impurities such as phosphorus are implanted into the semiconductor layers 31C. Note that the impurity concentration of the semiconductor layer 31C in the third region RC is higher than the impurity concentration of the semiconductor layer 31B in the second region RB.

The semiconductor layers 31B and 31C provided at the +Y side of the gate electrode 32 on the Y axis configure one region of the drain region and the source region of the thin film transistor 30 and, in the embodiment, configure a drain region 31d. The semiconductor layers 31B and 31C provided at the −Y direction side of the gate on the Y axis form the other region of the drain region and the source region of the thin film transistor 30 and, in the embodiment, configure a source region 31s. That is, impurities are added to the semiconductor layers 31C in the third region RC at a predetermined concentration required for the drain region and the source region of the thin film transistor 30.

As described above, the impurities are added to the semiconductor layers 31B in the second region RB at a concentration lower than the predetermined concentration. The semiconductor layer 31B forms an LDD 31l. The semiconductor layers 31B are disposed, and thus the impurity distribution and the electric field in the source/drain diffusion layer are relaxed during the operation of the thin film transistor 30 and the deterioration of the thin film transistor 30 is suppressed.

The fifth conductive layer 125 includes a sixth relay electrode 52. The sixth conductive layer 126 is formed of a conductive material having a light-shielding property, and includes the data line 16. The seventh conductive layer 127 includes the common wire 18.

A second dielectric film 63 is provided between the first conductive layer 121 as the second capacitance electrode 62 and the second conductive layer 122 as the first capacitance electrode 61. A first interlayer dielectric layer 71 is provided between the second conductive layer 122 and the third conductive layer 123. A second interlayer dielectric layer 72 is provided between the third conductive layer 123 and the semiconductor layer 31. A third interlayer dielectric layer 73 as a second insulating layer is provided between the fourth conductive layer 124 and the fifth conductive layer 125. A fourth interlayer dielectric layer 74 as a first insulating layer is provided between the fifth conductive layer 125 and the sixth conductive layer 126. A fifth interlayer dielectric layer 75 is provided between the sixth conductive layer 126 and the seventh conductive layer 127.

As illustrated in FIG. 5B, the capacitance element 60 includes the first capacitance electrode 61 disposed at a side closer to the scanning line 13 on the Z axis, that is, at the +Z side, and the second capacitance electrode 62 disposed at a side closer to the element substrate 111 than the first capacitance electrode 61 on the Z axis, that is, at the −Z side.

As illustrated in FIGS. 5C and 5D, the first capacitance electrode 61 of the capacitance element 60 is electrically coupled to the common wire 18 via a first relay electrode 81 provided in the sixth conductive layer 126 and a second relay electrode 82 provided in the fourth conductive layer 124. As illustrated in FIG. 5C, the common wire 18 and the second relay electrode 82 are electrically coupled to each other via the first relay electrode 81 disposed in the sixth conductive layer 126. As illustrated in FIG. 5C, the second relay electrode 82 is electrically coupled to an extension portion 61t of the first capacitance electrode 61 of the capacitance element 60. The extension portion 61t is a part of the first capacitance electrode 61 as will be described later.

The sixth relay electrode 52 and the second capacitance electrode 62 of the capacitance element 60 are electrically coupled to the pixel electrode 11 and the drain region 31d of the thin film transistor 30. As illustrated in FIG. 5D, the pixel electrode 11 is electrically coupled to a third relay electrode 83 provided in the seventh conductive layer 127. As illustrated in FIG. 5C, the third relay electrode 83 is electrically coupled to a fourth relay electrode 84 provided in the sixth conductive layer 126. The fourth relay electrode 84 is electrically coupled to the sixth relay electrode 52. As illustrated in FIG. 5B, the sixth relay electrode 52 is electrically coupled to a fifth relay electrode 85 provided in the fourth conductive layer 124. The fifth relay electrode 85 is electrically coupled to the second capacitance electrode 62 of the capacitance element 60.

The signal wire including the scanning lines 13 and the common wires 18, the thin film transistors 30, and the electrodes including the first relay electrodes 81 are provided in a light-shielding region SD that partitions the plurality of pixels P in a planar manner. The light-shielding region SD includes linear portions including the scanning lines 13 extending along the X axis and linear portions including the data lines 16 extending along the Y axis, and is provided in a lattice shape in plan view. The X axis corresponds to a first axis, and the Y axis corresponds to a second axis.

The sixth interlayer dielectric layer (not illustrated) is formed above the first substrate 10 in the display region E, that is, on the seventh conductive layer 127 provided at the +Z side of the first substrate 10. As illustrated in FIG. 5A, the pixel electrode 11 is provided corresponding to each of the plurality of pixels P in the display region E. The pixel electrode 11 is provided on the sixth interlayer dielectric layer 76 in a portion overlapping a part of the region RT partitioned as the pixel P in plan view. The region RT is a light-transmissive region that transmits at least a part of the color light incident on the liquid crystal device 100.

As illustrated in FIG. 5A, the region RT is surrounded by the adjacent scanning lines 13, 13 apart from each other on the X axis and the adjacent data lines 16, 16 apart from each other on the Y axis, and has a rectangular shape. The shape of the region RT in plan view is rectangular, for example, square. The width of the region RT on the X axis is at least larger than the width of the data line 16 on the X axis. The width of the region RT on the Y axis is at least larger than the width of the scanning line 13 on the Y axis, is equal to the width of the region RT on the X axis, and is within a range from 95% to 105% of the width of the region RT on the X axis in consideration of a manufacturing error of the liquid crystal device 100.

The pixel electrode layer configuring the pixel electrode 11 is disposed in most of the region RT except for the end side portion at the +Y side parallel to the X axis and the end side portion at the −X side parallel to the Y axis in plan view, and overlaps an extension portion 83t of the third relay electrode 83 of the pixel P. The pixel electrode layer configuring the pixel electrode 11 is provided on the side wall and the bottom portion of a contact hole formed at the −Y side and the central portion along the X axis of the region RT in plan view and coupled to the extension portion 83t of the third relay electrode 83 of the pixel P by a contact plug CNT11, and is electrically coupled to the third relay electrode 83 of the pixel P.

The pixel electrode layer configuring the pixel electrode 11 is provided to overlap a part of the region RT out of alignment with the region RT in plan view. The pixel electrode layer configuring the pixel electrode 11 is formed of, for example, a transparent conductor such as ITO.

As illustrated in FIG. 5A, in plan view, an end portion 11e anterior to, that is, at the +F side of a center line CL of the pixel electrode 11 in the F direction overlaps at least one of the scanning line 13 and the data line 16. The center line CL corresponds to a line passing through a center CP of a diagonal line TL parallel to the F direction of the pixel electrode 11 and orthogonal to the F direction and the diagonal line TL.

The end portion 11e of the pixel electrode 11 at the −Y side parallel to the X axis corresponds to the F direction, is adjacent to the region RT corresponding to the pixel electrode 11 in plan view, and overlaps the scanning line 13 extending parallel to the X axis at the-Y side of the region RT. The end portion 11e of the pixel electrode 11 at the +X side parallel to the Y axis corresponds to the F direction, is adjacent to the region RT corresponding to the pixel electrode 11 in plan view, and overlaps the data line 16 extending parallel to the Y axis at the +X side of the region RT. In the pixel electrode 11, the end portion 11e at the −Y side and the +X side, that is, a corner portion overlaps a region where the scanning line 13 at the −Y side of the region RT corresponding to the pixel electrode 11 and the data line 16 at the +X side intersect each other in plan view.

In each of the pixels P in the display region E of the liquid crystal device 100, a modulation region where incident light is modulated with a phase difference provided in the liquid crystal layer 5 is a region where the counter electrode 21, the region RT, and the pixel electrode 11 overlap one another and is a region where the pixel electrode 11 and the region RT substantially overlap each other in plan view. In the applied state in which a voltage is applied to the pixel electrode 11 and the counter electrode 21 of the liquid crystal device 100, that is, an on-state, the alignment of the plurality of liquid crystal molecules 50 in the liquid crystal layer 5 is less or more than expected, so that color unevenness or illuminance unevenness of image light occurs due to an alignment failure of the plurality of liquid crystal molecules 50 in the liquid crystal layer 5, and a domain region DM is generated due to the alignment failure of the plurality of liquid crystal molecules 50 in the liquid crystal layer 5 in the pixel electrode 11. When a pixel shift on the X axis and the Y axis is performed in order to increase the resolution of the image displayed by the image light emitted from the liquid crystal device 100, the domain region DM is remarkably generated.

In the liquid crystal device 100, as described above, the plurality of liquid crystal molecules 50 in the liquid crystal layer 5 are aligned in the F direction in the unapplied state of voltage. Therefore, in plan view, the domain region DM is generated in the end portion 11e at the +F side of the center line CL of the pixel electrode 11, specifically, the end portion 11e at the −Y side parallel to the X axis and the end portion 11e at the +X side parallel to the Y axis. In the liquid crystal device 100, the end portion 11e of the pixel electrode 11 and the domain region DM overlap the scanning line 13 at the −Y side adjacent to the region RT corresponding to the pixel electrode 11 and the data line 16 at the +X side adjacent to the region RT in plan view, and overlap the light-shielding region. Accordingly, it is unlikely for the observer of the image light emitted from the liquid crystal device 100 to visually recognize the domain region DM and the color unevenness or the illuminance unevenness of the image light, and the deterioration of the display quality of the liquid crystal device 100 is suppressed.

In the XY plane, intervals are provided between the pixel electrodes 11, 11 adjacent to each other. On the X axis, the interval between the end portion 11e of the pixel electrode 11 and the pixel electrode 11 adjacent thereto at the +X side is slightly smaller than the dimension of the data line 16, and is, for example, equivalent to the dimension of the data line 16. Accordingly, in the applied state of the liquid crystal device 100, the end portion 11e of the one pixel electrode 11 and the domain region DM generated by the alignment failure of the plurality of liquid crystal molecules 50 in the liquid crystal layer 5 do not extend from the region RT corresponding to the one pixel electrode 11 to the region RT corresponding to the other pixel electrode 11 over the data line 16 at the +X side, and the deterioration of the display quality in the region RT corresponding to the other pixel electrode 11 is suppressed.

On the X axis, in the applied state of the liquid crystal device 100, the interval between an end portion 11f posterior to the center line CL of the pixel electrode 11 and the pixel electrode 11 adjacent thereto at the −X side is at least smaller than the dimension of the data line 16, and is preferably about the minimum interval at which the insulation state between the pixel electrodes 11, 11 adjacent to each other is secured in consideration of a manufacturing error. As described above, since the end portion 11f of the pixel electrode 11 is adjacent to the data line 16 without overlapping the data line 16 adjacent to the pixel electrode 11, the reduction of the modulation region of the pixel P is suppressed as much as possible, and the deterioration of the display quality in the region RT corresponding to the pixel electrode 11 is suppressed.

Similarly, on the Y axis, the interval between the pixel electrodes 11, 11 is smaller than the dimension of the scanning line 13. Accordingly, the domain region DM that may be generated as described above in the on-state of the liquid crystal device 100 does not extend from the region RT corresponding to one pixel electrode 11 to the region RT corresponding to the other pixel electrode 11 over the scanning line 13 at the −Y side, and the deterioration of the display quality in the region RT corresponding to the other pixel electrode 11 is suppressed.

On the Y axis, the interval between the end portion 11f of the pixel electrode 11 and the pixel electrode 11 adjacent thereto at the +Y side in the applied state of the liquid crystal device 100 is at least smaller than the dimension of the scanning line 13, and is preferably about the minimum interval at which the insulation state between the pixel electrodes 11, 11 adjacent to each other is secured in consideration of a manufacturing error. Accordingly, since the end portion 11f of the pixel electrode 11 is adjacent to the scanning line 13 without overlapping the scanning line 13 adjacent to the pixel electrode 11, the reduction of the modulation region of the pixel P is suppressed, and the deterioration of the display quality in the region RT corresponding to the pixel electrode 11 is suppressed.

As an example, when the widths of the pixel P and the region RT along the X axis and the Y axis are 8.1 μm, and the dimension of the scanning line 13 along the Y axis and the dimension of the data line 16 along the X axis are 0.65 μm, the interval between the end portion 11f of the pixel electrode 11 and the pixel electrode 11 adjacent thereto along the X axis is about 0.6 μm, and the interval between the end portion 11f of the pixel electrode 11 and the pixel electrode 11 adjacent thereto along the Y axis is about 0.6 μm.

Although not illustrated, a dummy pixel electrode is provided to correspond to each of the plurality of dummy pixels DP in the dummy pixel region DF. The dummy pixel electrode is provided on the sixth interlayer dielectric layer 76 in a region overlapping at least a part of the light-transmissive region partitioned as the dummy pixel DP in plan view. The shape of the dummy pixel electrode in plan view is the same as the shape of the pixel electrode 11 in plan view, but may be different from the shape of the pixel electrode 11 in plan view as appropriate.

The dummy pixel region DF is partitioned into, for example, a first dummy region, a second dummy region, and a third dummy region from the side closer to the display region E in the XY plane. The first dummy region is a region of the dummy pixel region DF that is adjacent to the display region E and closest to the display region E in the XY plane.

The first dummy region includes several tens of dummy pixels DP along the X axis or the Y axis orthogonal to each side of the display region E in the XY plane. The dummy pixels DP in the first dummy region have the same structures and component elements as the pixels P in the display region E. For example, in the first dummy region, similarly to the region RT, in the light-transmissive region which is surrounded by the scanning lines 13, 13 adjacent to each other and the data lines 16, 16 adjacent to each other in plan view and through which the color light can be transmitted, the seventh conductive layer 127 forming the third relay electrode 83 and the seventh conductive layer 127 forming the common wire to which a common potential is supplied are provided immediately below the sixth interlayer dielectric layer 76, that is, on the fifth interlayer dielectric layer 75 provided at the −Z side. The common wire described above may be the same as the common wire 18.

In the first dummy region, a dummy pixel electrode layer configuring the dummy pixel electrode is provided on at least the wall surface and the bottom of each of first peripheral region contact holes in plan view and the sixth interlayer dielectric layer 76 forming the peripheral edge portion of the opening in plan view. A first peripheral region contact plug is formed simultaneously with the contact plug CNT11 in the step of forming the contact plug CNT11 in the sixth interlayer dielectric layer 76. In the first dummy region, the first peripheral region contact plug is formed, for example, at the −Y side and in the center portion along the X axis of the light-transmissive region of the dummy pixel DP in plan view. In the first dummy region, the dummy pixel electrode layer includes a portion overlapping the first peripheral region contact plug, the third relay electrode 83, and the common wire described above formed in the dummy pixel region DF in plan view, and is formed in a rectangular frame shape.

The second dummy region is a region of the dummy pixel region DF that is adjacent to the first dummy region in the XY plane, surrounds the first dummy region, and is provided immediately outside the first dummy region. The dummy pixel DP is not formed in the second region. In the second dummy region, the seventh conductive layer 127 forming the third relay electrode 83 is not formed, but only the seventh conductive layer 127 forming the common wire is formed on the fifth interlayer dielectric layer 75.

The third dummy region is a region of the dummy pixel region DF that is adjacent to the second dummy region in the XY plane, surrounds the second dummy region, is provided outside the second dummy region and at the outermost side of the dummy pixel region DF. The dummy pixel DP is not formed in the third dummy region either. The seventh conductive layer 127 is not formed in the third dummy region on the fifth interlayer dielectric layer 75.

In the first dummy region, the dummy pixel electrode layer is electrically coupled to the third relay electrode 83 provided in the region RT. A video signal of the liquid crystal device 100 is supplied to the dummy pixel electrode layer in the first dummy region. In the second dummy region, the dummy pixel electrode layer is electrically coupled to the common wire provided in the light-transmissive region. The common potential in the liquid crystal device 100 is applied to the dummy pixel electrode layer in the second dummy region. In the third dummy region, the dummy pixel electrode layer is not electrically coupled to any wire. A floating potential is applied to the dummy pixel electrode layer in the third dummy region.

In the liquid crystal device 100, the transverse electric field of the pixel electrodes 11, 11 adjacent to each other in the XY plane in the on-state causes disclination of the plurality of liquid crystal molecules 50 of the liquid crystal layer 5 in a region corresponding to the F direction and overlapping the end portion anterior in the F direction, that is, at the +F side in the pixel electrode 11, that is, the end portion 11e of the pixel electrode 11 in plan view. As a result, the alignment of the plurality of liquid crystal molecules 50 of the liquid crystal layer 5 in the region overlapping the end portion 11e of the pixel electrode 11 in plan view is not as expected, and a domain region where the transmittance of color light is lower than most of the pixel electrode 11 other than the end portion 11e is generated. However, in the liquid crystal device 100, since the end portion 11e of the pixel electrode 11 overlaps the light-shielding region SD formed by the scanning line 13 and the data line 16 which are originally formed to surround the region RT corresponding to the pixel electrode 11 in plan view, it is difficult for the observer to visually recognize the domain region, and the deterioration of the display quality of the liquid crystal device 100 is suppressed.

In the dummy pixel region DF of the first peripheral region F1, since the partition member 23 surrounding the display region E in plan view is disposed closer to the incident side of the color light than the dummy pixel electrode layer, the color light does not enter the liquid crystal layer 5 and is not affected by the alignment failure of the plurality of liquid crystal molecules 50 of the liquid crystal layer 5.

### Modifications of Liquid Crystal Device of Present Embodiment

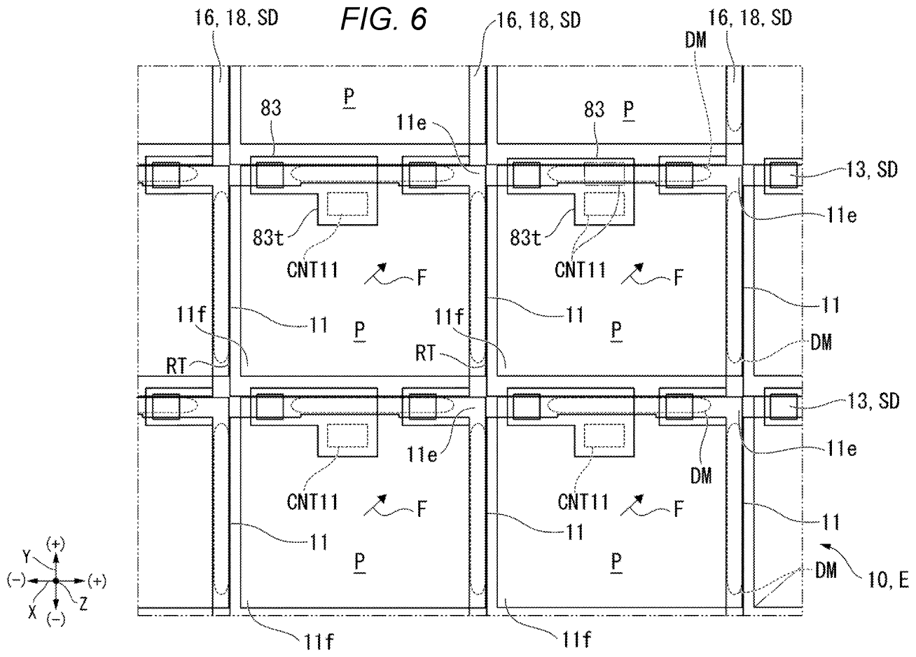

FIG. 6 is a plan view of pixels P of a modification of the liquid crystal device 100 of the present embodiment described above, and is a plan view of the first substrate 10 of the modification. As illustrated in FIG. 6, the F direction of the present modification indicates a direction of movement from the −Y side to the +Y side with movement from the −X side to the +X side along the X axis.

In the present modification, the end portion 11e at the +Y side parallel to the X axis in the pixel electrode 11 corresponds to the F direction, is adjacent to the region RT corresponding to the pixel electrode 11 in plan view, and overlaps the scanning line 13 extending parallel to the X axis at the +Y side of the region RT. The end portion 11e of the pixel electrode 11 at the +X side parallel to the Y axis corresponds to the F direction, is adjacent to the region RT corresponding to the pixel electrode 11 in plan view, and overlaps the data line 16 extending parallel to the Y axis at the +X side of the region RT.

Also in the configuration of the present modification, on the X axis, the domain region DM generated due to the alignment of the plurality of liquid crystal molecules 50 of the liquid crystal layer 5 less than expected in the on-state of the liquid crystal device 100 does not overlap the region RT corresponding to the pixel P in plan view, overlaps the scanning line 13 or the data line 16 as the light-shielding region, does not extend from the region RT corresponding to one pixel electrode 11 of the pixel electrodes 11, 11 adjacent to each other to the region RT corresponding to the other pixel electrode 11 over the data line 16, and the deterioration of the display quality in the region RT corresponding to the other pixel electrode 11 is suppressed. Similarly, on the Y axis, the domain region DM which may be generated as described above in the on-state of the liquid crystal device 100 does not extend from the region RT corresponding to one pixel electrode 11 to the region RT corresponding to the other pixel electrode 11 over the scanning line 13, and the deterioration of the display quality in the region RT corresponding to the other pixel electrode 11 is suppressed.

In another modification, as illustrated in the configurations of the pixels P in FIGS. 4 and 6, in plan view, the position where the contact plug CNT11 is formed may be changed along the Y axis, the contact plug CNT11 may be formed in a region overlapping the third relay electrode 83 and the scanning line 13, and the extension portion 83t may not be provided. As a result, the amount of color light transmitted through the pixel P and the region RT increases, the amount of image light generated in the pixel P increases, and the display quality of the liquid crystal device 100 is increased.

It is desirable that the dimensions of the contact plug CNT11 along the Y axis and the X axis be set to be smaller within a range that does not affect the action of electrically coupling the pixel electrode 11 and the third relay electrode 83. When the contact plug CNT11 overlaps the scanning line 13 in plan view as in the above-described modification, the dimension of the contact plug CNT11 along the Y axis is set to be equal to the dimension of the scanning line 13 along the Y axis, or is set to be smaller than the dimension of the scanning line 13 along the Y axis by a manufacturing error.

### Electronic Apparatus

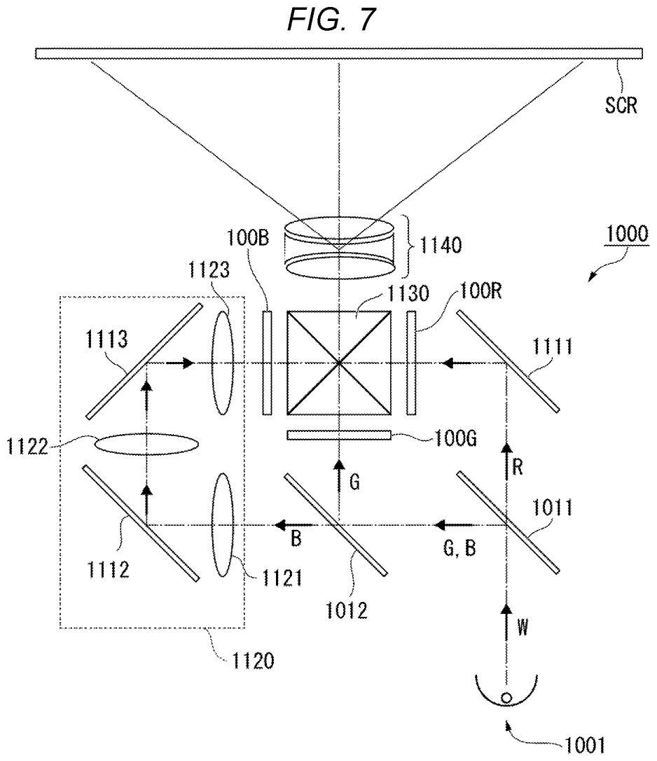

In the present embodiment, a projector 1000 will be described as an example of an electronic apparatus including the liquid crystal device 100. FIG. 7 is a schematic diagram of the projector 1000. As illustrated in FIG. 7, the projector 1000 includes a light source device 1001, dichroic mirrors 1011 and 1012, liquid crystal devices 100B, 100G, and 100R, reflection mirrors 1111, 1112, and 1113, relay lenses 1121, 1122, and 1123, a cross dichroic prism 1130, and a projection optical system 1140.

The light source device 1001 emits a white light WL. The light source device 1001 is, for example, a discharge type lamp unit, but may be a light emitting diode, a laser, or the like or a device in which a light emitter that emits a blue light and a phosphor that converts a part of the blue light emitted from the light emitter into a yellow light and emits the yellow light are combined, and is not limited to a specific light source device.

The white light W emitted from the light source device 1001 is separated by the two dichroic mirrors 1011 and 1012 into color lights of three colors having different wavelength ranges. The color lights of the three colors include a red light R, a green light G, and a blue light B. The dichroic mirror 1011 transmits the red light R and reflects the green light G and the blue light B shorter in wavelength than the red light R. The red light R transmitted through the dichroic mirror 1011 is reflected by the reflection mirror 1111 and enters the liquid crystal device 100R. The green light G reflected by the dichroic mirror 1011 is reflected by the dichroic mirror 1012 and then enters the liquid crystal device 100G. The blue light B reflected by the dichroic mirror 1011 is transmitted through the dichroic mirror 1012 and is emitted to a relay lens system 1120.

The relay lens system 1120 includes the relay lenses 1121, 1122, and 1123 and the reflection mirrors 1112 and 1113. The optical path of the blue light B from the dichroic mirror 1011 to the liquid crystal device 100B is longer than the optical path of the green light G from the dichroic mirror 1011 to the liquid crystal device 100G and the optical path of the red light R from the dichroic mirror 1011 to the liquid crystal device 100R. Therefore, the luminous flux of the blue light B tends to be larger than the luminous fluxes of the green light G and the red light R. By using the relay lens 1122, the expansion of the luminous flux of the blue light B is suppressed. The blue light B incident on the relay lens system 1120 is reflected by the reflection mirror 1112 and converged in the vicinity of the relay lens 1122 by the relay lens 1121. The blue light B enters the liquid crystal device 100B through the reflection mirror 1113 and the relay lens 1123.

The liquid crystal devices 100R, 100G, and 100B are light modulation devices in the projector 1000. The liquid crystal device 100 described above is applied to the liquid crystal devices 100R, 100G, and 100B.

Each of the liquid crystal devices 100R, 100G, and 100B is electrically coupled to an external control device of the projector 1000. An image signal that designates the gradation level of each of the red light R, the green light G, and the blue light B is supplied from the external control device for each color light, and is processed in an integrated circuit attached to each of the liquid crystal devices 100R, 100G, and 100B. The liquid crystal devices 100R, 100G, and 100B are driven according to the image signals received from the respective integrated circuits. The liquid crystal device 100R modulates the red light R incident thereon. The liquid crystal device 100G modulates the green light G incident thereon. The liquid crystal device 100B modulates the blue light B incident thereon.

The red light R, the green light G, and the blue light B modulated by the liquid crystal devices 100R, 100G, and 100B enter the cross dichroic prism 1130 from three directions. The cross dichroic prism 1130 is a color combining system in the projector 1000 and combines the incident red light R, green light G, and blue light B. In the cross dichroic prism 1130, the red light R and the blue light B are reflected by 90 degrees with respect to the respective incident directions, and the green light G is transmitted. As a result, the red light R, the green light G, and the blue light B combined with one another are emitted in the same direction. The red light R, the green light G, and the blue light B are combined as a display light for displaying a color image, and emitted from the cross dichroic prism 1130 toward the projection optical system 1140.

The projection optical system 1140 is disposed facing the outside of the projector 1000. The display light is enlarged and emitted via the projection optical system 1140, and is projected onto a screen SCR as a projection target.

### Functions and Effects

The liquid crystal device 100 of the present embodiment described above includes the first substrate (substrate) 10 and the second substrate (substrate) 20 forming a pair, and the liquid crystal layer 5 sandwiched between the first substrate 10 and the second substrate 20 along the Z axis. The first substrate 10 includes the plurality of scanning lines 13, the plurality of data lines 16, the pixel electrodes 11, and the alignment film 12. The scanning line 13 extends along the X axis (first axis) in plan view when viewed along the Z axis. The data line 16 extends along the Y axis (second axis) intersecting the X axis in plan view. The pixel electrode 11 is disposed to include a part of the region RT surrounded by the scanning lines 13, 13 adjacent to each other and the data lines 16, 16 adjacent to each other in plan view, and has the rectangular shape in plan view. The alignment film 12 is provided at the side in contact with the liquid crystal layer 5 in the first substrate 10, that is, at the most +Z side, and provides a pretilt to the liquid crystal molecules 50 contained in the liquid crystal layer 5. The second substrate 20 has the counter electrode 21 and the alignment film 22. The counter electrode 21 faces the plurality of pixel electrodes 11 with the liquid crystal layer 5 in between on the Z axis. The alignment film 22 is provided at the side in contact with the liquid crystal layer 5 in the second substrate 20, that is, at the most −Z side, and provides a pretilt to the liquid crystal molecules 50 together with the alignment film 12. In the liquid crystal device 100 of the present embodiment, in plan view, in the pixel electrode 11, the end portion 11e anterior to the center line CL in the F direction (predetermined direction) in which the liquid crystal molecules 50 are inclined overlaps at least one of the scanning line 13 and the data line 16.

In the liquid crystal device 100 of the present embodiment, since the end portion 11e of the pixel electrode 11 overlaps at least one of the scanning line 13 and the data line 16 as the light-shielding regions in plan view, the domain region DM which is generated due to the alignment of the plurality of liquid crystal molecules 50 of the liquid crystal layer 5 less than expected in the on-state of the liquid crystal device 100 does not overlap the region RT as the light-transmissive region corresponding to the pixel electrode 11 in plan view, and the deterioration of the display quality in the region RT can be suppressed.

In the liquid crystal device 100 of the present embodiment, in the unapplied state in which no voltage is applied to the pixel electrodes 11 and the counter electrode 21, the major axis GX of the liquid crystal molecule 50 from the end 50a at the first substrate 10 side, that is, the −Z side to the end 50b at the second substrate 20 side, that is, the +Z side is inclined in the F direction (predetermined direction) in plan view with respect to the Z axis parallel to the thickness direction of the first substrate 10.

In the liquid crystal device 100 of the present embodiment, it is possible to shift the pixel electrode 11 with respect to the region RT of the pixel P in the F direction in which the major axis GX from the end 50a to the end 50b of the liquid crystal molecule 50 is inclined in the unapplied state in plan view, and to overlap the domain region DM with the scanning line 13 or the data line 16 as the light-shielding region SD in the F direction with respect to the region RT as described above. According to the liquid crystal device 100 of the present embodiment, it is possible to suppress the deterioration of the display quality in the region RT without overlapping the domain region DM with the region RT corresponding to the pixel electrode 11 in plan view.

In the liquid crystal device 100 of the present embodiment, when viewed in the cross section cut along the F direction so as to include the Z axis as exemplified in FIG. 3, the angle θ formed by the major axis GX of the liquid crystal molecule 50 contained in the liquid crystal layer 5 in the unapplied state of voltage to the pixel electrodes 11 and the counter electrode 21 with respect to the Z axis is from 4° to 6°.

In the liquid crystal device 100 of the embodiment, since the angle θ of the plurality of liquid crystal molecules 50 of the liquid crystal layer 5 is appropriately set in the unapplied state of voltage, for example, when the plurality of liquid crystal molecules 50 operate in the normally black mode in the voltage applied state, that is, the on-state, the angle of the liquid crystal molecules 50 with respect to the Z axis can be increased, and the amount of phase modulation provided to the color light incident on the liquid crystal layer 5 can be sufficiently secured.

In the liquid crystal device 100 of the present embodiment, in plan view, the end portion 11f posterior to the center line CL of the pixel electrode 11 is disposed at the position different from those of the scanning line 13 and the data line 16, and is preferably adjacent to at least one of the scanning line 13 and the data line 16.

In the liquid crystal device 100 of the present embodiment, when the end portion 11f of the pixel electrode 11 is adjacent to the scanning line 13 or the data line 16 at a minimum interval, the color light incident on the region RT and the modulation region of the pixel P is unlikely to be blocked, and it is possible to increase the transmission amount of the color light in the region RT of the pixel P corresponding to the pixel electrode 11 and the amount of the image light emitted from the pixel P.

In the liquid crystal device 100 of the present embodiment, the first substrate 10 further includes the TFT (switching element) 30 and the contact plug CNT11. The TFT 30 is disposed farther from the liquid crystal layer 5 than the pixel electrode 11 on the Z axis, and is disposed at the −Z side of the pixel electrode 11. The contact plug CNT11 couples the pixel electrode 11 and the seventh conductive layer 127 including the common wire (wire) 18. In plan view, the contact plug CNT11 may overlap a portion anterior to the center line CL of the pixel electrode 11, may overlap a part of at least one of the scanning line 13 and the data line 16 which is disposed at the center of the region RT on the X axis (one axis) of the X axis and the Y axis and extends along the X axis on the Y axis (the other axis), and may overlap, for example, the center portion on the X axis of the scanning line 13 adjacent to the region RT at the −Y side.

In the modification of the liquid crystal device 100 of the embodiment, the contact plug CNT11 as the light-shielding region overlaps the scanning line 13 or the data line 16 in plan view. According to the modification of the liquid crystal device 100 of the present embodiment, it is possible to suppress the reduction of the modulation region of the pixel P as much as possible, and to increase the transmission amount of the color light in the region RT of the pixel P corresponding to the pixel electrode 11 and the amount of the image light emitted from the pixel P.

In the modification of the liquid crystal device 100 of the present embodiment, the contact plug CNT11 overlaps the scanning line 13 extending along the X axis on the Y axis in plan view.

In the modification of the liquid crystal device 100 of the embodiment, the contact plug CNT11 as the light-shielding region overlaps, for example, the scanning line 13 in plan view. According to the modification of the liquid crystal device 100 of the present embodiment, it is possible to suppress the reduction of the modulation region of the pixel P as much as possible, and to increase the transmission amount of the color light in the region RT of the pixel P corresponding to the pixel electrode 11 and the amount of the image light emitted from the pixel P.

In the modification of the liquid crystal device 100 of the embodiment, the dimension of the contact plug CNT11 on the Y axis is equal to the dimension of the scanning line 13 extending along the X axis on the Y axis.

According to the modification of the liquid crystal device 100 of the embodiment, it is possible to suppress the reduction of the modulation region of the pixel P as much as possible, and to further increase the transmission amount of the color light in the region RT of the pixel P corresponding to the pixel electrode 11 and the amount of the image light emitted from the pixel P.

As another modification of the liquid crystal device 100 of the present embodiment, the contact plug CNT11 may overlap the end portion 11e anterior to the center line CL of the pixel electrode 11, may be disposed at the center of the region RT on the Y axis (one axis) of the X axis and the Y axis, and may overlap the data line 16 extending along the Y axis on the X axis (the other axis). In this case, it is desirable that the dimension of the contact plug CNT11 on the X axis is set to be equal to the dimension of the data line 16 or smaller than the dimension of the data line 16 by the manufacturing error.

In the liquid crystal device 100 of the present embodiment, the X axis and the Y axis are orthogonal to each other in plan view. The F direction forms the angle from 40° to 50°, preferably an angle of 45° with respect to each of the X axis and the Y axis. The end portion 11e of the pixel electrode 11 anterior to the center line CL in the F direction overlaps both the scanning line 13 and the data line 16.

According to the modification of the liquid crystal device 100 of the embodiment, as the maximum region where the domain region DM may be generated in the pixel electrode 11 in plan view, the end portion 11e parallel to the X axis and the end portion 11e parallel to the Y axis are overlapped with the scanning line 13 and the data line 16, and thus it is possible to prevent the shortage of the transmission amount and the modulation amount of the color light in the region RT of the pixel P corresponding to the pixel electrode 11 and to favorably suppress the deterioration of the display quality in the region RT.

In the liquid crystal device 100 of the present embodiment, the planar shape of the region RT of the pixel P is the square shape. The plan view shapes of the region RT and the pixel electrode 11 being the square shapes includes a case where a convex portion is provided in at least one side of four sides forming a rectangular shape with a dimension of a degree of manufacturing error or a state where a concave portion of a degree of manufacturing error is provided, and includes a state where, with one side of four sides coupling corners of the rectangular shape as a reference, a length or a width of another side is within a range from 95% to 105%.

According to the liquid crystal device 100 of the present embodiment, it is possible to secure the area of each pixel P, prevent the shortage of the transmission amount and the modulation amount of the color light by the domain region DM in the region RT to the same extent on the X axis and the Y axis, and suppress the deterioration of the display quality in the region RT.

In the liquid crystal device 100 of the embodiment, the scanning lines 13 and the data lines 16 are formed of a conductive material having a light-shielding property.

According to the liquid crystal device 100 of the present embodiment, the scanning lines 13 and the data lines 16 configure the light-shielding regions SD that partition the plurality of pixels P and the regions RT that are the light-transmissive regions in plan view.

The projector (electronic apparatus) 1000 of the present embodiment includes the liquid crystal devices 100B, 100G, and 100R configured similarly to the liquid crystal device 100 of the present embodiment described above.

According to the projector 1000 of the present embodiment, it is possible to suppress deterioration of display quality based on the image lights emitted from the liquid crystal devices 100B, 100G, and 100R.

Some preferable embodiments of the present disclosure have been described hereinabove in detail. However, the present disclosure is not limited to such specific embodiments, and various modifications and changes can be made thereto within the scope of the present disclosure set forth in the appended claims.

For example, in the embodiments described above, the projector is exemplified as the electronic apparatus, but the electronic apparatus is not limited to the projector. The electronic apparatus including the electro-optical device described above may be, for example, a stereolithography device, or may be an apparatus that utilizes image light converted by an electro-optical device other than a projector or a stereolithography device.

### Summary of Present Disclosure

The present disclosure will be summarized below as appendices.

(Appendix 1) A liquid crystal device includes a pair of substrates, and a liquid crystal layer sandwiched between the pair of substrates, wherein a first substrate of the pair of substrates includes a plurality of scanning lines extending along a first axis in plan view, a plurality of data lines extending along a second axis intersecting the first axis in plan view, a pixel electrode disposed to include a part of a region surrounded by the scanning lines adjacent to each other and the data lines adjacent to each other in plan view and having a rectangular shape in plan view, and an alignment film provided at a side in contact with the liquid crystal layer and providing a pretilt to liquid crystal molecules contained in the liquid crystal layer, a second substrate of the pair of substrates includes a counter electrode facing the pixel electrode with the liquid crystal layer in between, and an alignment film provided at a side in contact with the liquid crystal layer and providing a pretilt to the liquid crystal molecules, and, in plan view, an end portion of the pixel electrode anterior to a center line in a predetermined direction in which the liquid crystal molecules are inclined in the pixel electrode overlaps at least one line of the scanning line and the data line.

According to the configuration of Appendix 1, since the end portion of the pixel electrode overlaps at least one of the scanning line and the data line as the light-shielding regions in plan view, the domain region which is generated due to the alignment of the plurality of liquid crystal molecules of the liquid crystal layer less than expected in the on-state of the electro-optical device does not overlap the light-transmissive region corresponding to the pixel electrode in plan view, and the deterioration of the display quality in the light-transmissive region can be suppressed.

(Appendix 2) In the liquid crystal device according to Appendix 1, in an unapplied state in which no voltage is applied to the pixel electrode and the counter electrode, a major axis of the liquid crystal molecule from an end at the first substrate side to an end at the second substrate side is inclined in the predetermined direction in plan view with respect to a thickness direction of the first substrate.

In the configuration of Appendix 2, it is possible to shift the pixel electrode in the predetermined direction in which the major axis of the liquid crystal molecule 50 from the end at the first substrate side to the end at the second substrate side is inclined with respect to the light-transmissive region of the pixel in the unapplied state in plan view, and to overlap the domain region with the scanning line or the data line as the light-shielding region anterior in the predetermined direction with respect to the light-transmissive region. According to the configuration of Appendix 2, it is possible to suppress deterioration of display quality in the light-transmissive region of the pixel without overlapping the domain region with the light-transmissive region corresponding to the pixel electrode in plan view.

(Appendix 3) In the liquid crystal device according to Appendix 1, an angle formed by the major axis of the liquid crystal molecule in the unapplied state with respect to the thickness direction of the first substrate is from 4° to 6°.

According to the configuration of Appendix 3, when the plurality of liquid crystal molecules contained in the liquid crystal layer operate, for example, in a normally black mode in a state where a voltage is applied, that is, in an on-state, it is possible to further increase the angle of the liquid crystal molecules with respect to the third axis and to sufficiently secure the amount of phase modulation provided to the color light incident on the liquid crystal layer.

(Appendix 4) In the liquid crystal device according to any one of Appendices 1 to 3, in plan view, an end portion of the pixel electrode posterior to the center line is disposed at a position different from those of the scanning line and the data line, and is adjacent to at least one line of the scanning line and the data line.

According to the configuration of Appendix 4, the color light incident on the light-transmissive region of the pixel corresponding to the pixel electrode is less likely to be blocked, and it is possible to increase the transmission amount of the color light in the light-transmissive region of the pixel and the amount of image light emitted from the pixel.

(Appendix 5) In the liquid crystal device according to any one of Appendices 1 to 4, the first substrate includes a switching element disposed farther from the liquid crystal layer than the pixel electrode in a thickness direction of the first substrate, and a contact plug coupling the pixel electrode and a wire in the thickness direction of the first substrate, and, in plan view, the contact plug overlaps a portion of the pixel electrode anterior to the center line, is disposed at a center of the region on one axis of the first axis and the second axis, and overlaps a part of at least one line of the scanning line and the data line extending along the one axis on the other axis of the first axis and the second axis.

According to the configuration of Appendix 5, the color light incident on the light-transmissive region of the pixel corresponding to the pixel electrode is less likely to be blocked by the contact plug, and it is possible to increase the transmission amount of the color light in the light-transmissive region of the pixel and the amount of the image light emitted from the pixel.

(Appendix 6) In the liquid crystal device according to Appendix 5, in plan view, the contact plug overlaps the scanning line or the data line extending along the one axis on the other axis.

According to the configuration of Appendix 6, the color light incident on the light-transmissive region of the pixel corresponding to the pixel electrode is less likely to be blocked by the contact plug, and it is possible to increase the transmission amount of the color light in the light-transmissive region of the pixel and the amount of image light emitted from the pixel.

(Appendix 7) In the liquid crystal device according to Appendix 6, a dimension of the contact plug on the other axis is equal to a dimension of the scanning line or the data line extending along the one axis on the other axis.

According to the configuration of Appendix 7, the color light incident on the light-transmissive region of the pixel corresponding to the pixel electrode is not blocked by the contact plug, and it is possible to further increase the transmission amount of the colored light in the light-transmissive region of the pixel and the amount of the image light emitted from the pixel.

(Appendix 8) In the liquid crystal device according to any one of Appendices 1 to 7, in plan view, the first axis and the second axis are orthogonal to each other, the predetermined direction forms an angle from 40° to 50° with respect to each of the first axis and the second axis, and the end portion of the pixel electrode anterior to the center line in the predetermined direction overlaps both the scanning line and the data line.

According to the configuration of Appendix 8, as the maximum region where the domain region may be generated in the pixel electrode when seen in a plan view, the end portion parallel to the first axis and the end portion parallel to the second axis are overlapped with the scanning line and the data line, and thus it is possible to prevent shortage of the transmission amount and the modulation amount of the color light in the light-transmissive region of the pixel corresponding to the pixel electrode and to favorably suppress deterioration of the display quality of the liquid crystal device.

(Appendix 9) In the liquid crystal device according to Appendix 8, a shape of the region in plan view is a square shape.

According to the configuration of Appendix 9, it is possible to secure the area of the pixel, prevent the shortage of the transmission amount and the modulation amount of the color light by the domain region in the light-transmissive region of the pixel to the same extent on the first axis and the second axis, and suppress the deterioration of the display quality of the liquid crystal device.

(Appendix 10) In the liquid crystal device according to any one of Appendices 1 to 9, the scanning line and the data line are formed of a conductive material having a light-shielding property.

In the configuration of Appendix 10, the scanning lines and the data lines configure light-shielding regions that partition a plurality of pixels and the light-transmissive regions in plan view.

(Appendix 11) An electronic apparatus includes the liquid crystal device according to any one of Appendices 1 to 10.

According to the configuration of Appendix 11, since the liquid crystal device described above is provided, it is possible to suppress deterioration of display quality in the electronic apparatus based on the image light emitted from the liquid crystal device.

What is claimed is:

1. A liquid crystal device comprising:
a pair of substrates; and
a liquid crystal layer sandwiched between the pair of substrates, wherein
a first substrate of the pair of substrates includes
a plurality of scanning lines extending along a first axis in plan view,
a plurality of data lines extending along a second axis intersecting the first axis in plan view,
a pixel electrode disposed to include a part of a region surrounded by the scanning lines adjacent to each other and the data lines adjacent to each other in plan view and having a rectangular shape in plan view, and
an alignment film provided at a side in contact with the liquid crystal layer and providing a pretilt to liquid crystal molecules contained in the liquid crystal layer,
a second substrate of the pair of substrates includes
a counter electrode facing the pixel electrode with the liquid crystal layer in between, and
an alignment film provided at a side in contact with the liquid crystal layer and providing a pretilt to the liquid crystal molecules, and
in plan view, an end portion of the pixel electrode anterior to a center line in a predetermined direction in which the liquid crystal molecules are inclined in the pixel electrode overlaps at least one line of the scanning line and the data line.

2. The liquid crystal device according to claim 1, wherein
in an unapplied state in which no voltage is applied to the pixel electrode and the counter electrode, a major axis of the liquid crystal molecule from an end at the first substrate side to an end at the second substrate side is inclined in the predetermined direction in plan view with respect to a thickness direction of the first substrate.

3. The liquid crystal device according to claim 2, wherein
an angle formed by the major axis of the liquid crystal molecule in the unapplied state with respect to the thickness direction of the first substrate is from 4° to 6°.

4. The liquid crystal device according to claim 1, wherein
in plan view, an end portion of the pixel electrode posterior to the center line is disposed at a position different from those of the scanning line and the data line, and is adjacent to at least one line of the scanning line and the data line.

5. The liquid crystal device according to claim 1, wherein
the first substrate includes:
a switching element disposed farther from the liquid crystal layer than the pixel electrode in a thickness direction of the first substrate; and
a contact plug coupling the pixel electrode and a wire in the thickness direction of the first substrate, and
in plan view, the contact plug overlaps a portion of the pixel electrode anterior to the center line, is disposed at a center of the region on one axis of the first axis and the second axis, and overlaps a part of at least one line of the scanning line and the data line extending along the one axis on the other axis of the first axis and the second axis.

6. The liquid crystal device according to claim 5, wherein
in plan view, the contact plug overlaps the scanning line or the data line extending along the one axis on the other axis.

7. The liquid crystal device according to claim 6, wherein
a dimension of the contact plug on the other axis is equal to a dimension of the scanning line or the data line extending along the one axis on the other axis.

8. The liquid crystal device according to claim 1, wherein
in plan view, the first axis and the second axis are orthogonal to each other, the predetermined direction forms an angle from 40° to 50° with respect to each of the first axis and the second axis, and the end portion of the pixel electrode anterior to the center line in the predetermined direction overlaps both the scanning line and the data line.

9. The liquid crystal device according to claim 8, wherein
a shape of the region in plan view is a square shape.

10. The liquid crystal device according to claim 1, wherein
the scanning line and the data line are formed of a conductive material having a light-shielding property.

11. An electronic apparatus comprising the liquid crystal device according to claim 1.
